(19) United States
(12) Patent Application Publication
(10) Pub. No.: US 2015/0369536 A1
(43) Pub. Date: Dec. 24, 2015

(54) TREATMENT DEVICE FOR FLOWABLE MATERIAL

(71) Applicant: Christian SCHIAVOLIN, (US)

(72) Inventor: Christian SCHIAVOLIN, Padova (IT)

(21) Appl. No.: 14/764,669

(22) PCT Filed: Jan. 29, 2014
(86) PCT No.: PCT/EP2014/051736

§ 371 Date: Jul. 30, 2015

(30) Foreign Application Priority Data
Jan. 31, 2013 (IT) PD2013A000022

(51) Int. Cl. F26B 3/30; B01F 7/00; F26B 11/12; B08B 1/00; B08B 1/04

(52) U.S. Cl. CPC F26B 3/30; B08B 1/002; B08B 1/005; B08B 1/04; F26B 11/12; B01F 7/00

(57) ABSTRACT

A treatment device (1) for flowable material comprises a container body (2) suitable for receiving a predefined quantity of said flowable material and delimited by a wall (3), at least one radiating device (20, 30) which radiates infrared radiation to heat said flowable material in said container body (2), a cleaning device (10, 11, 12) fixed at one end thereof (11a) to a base (110, 6) of said container body (2) and rotatable around an axis (X) of said container body (2), and a cleaning device (10, 11, 12) provided with a scraping device (12) provided at an end portion (1 ib) of said cleaning device (10, 11, 12) opposite said first end (11a) and arranged to run in the rotation of said cleaning device (10, 11, 12) over at least one segment (T) of a free stretch (3′) of the said wall (3) defined between a free surface (S) of said material and a mouth (2′) of said container (2) in order to scrape off any residues of said flowable material from said at least one segment (T) of said free stretch of wall (3′).

### TECHNICAL FIELD

The present invention relates to a treatment device for flowable material having the features set out in the preamble of the main claim.

The device of the invention is particularly suited for use in processing methods for flowable material which require a heat treatment, especially a heat treatment by infrared radiation.

Although the description refers directly to the treatment of plastics materials, the device may also be used in other sectors, for instance in the treatment of flowing foodstuff material.

### TECHNOLOGICAL BACKGROUND

The processing methods for many materials, for instance plastics materials, include stages of heat treatment in order to dry or dehumidify these materials before any subsequent processing stages, these materials tending to absorb moisture to an extent that depends on the type of material and the operating conditions.

Moisture has adverse effects on subsequent processing stages and, in the case of plastics materials, impairs aesthetic and mechanical properties such as the tensile, bending and impact strength of the end product.

The materials therefore need to be treated to remove any moisture from them, before subjecting them to any subsequent processing stages.

In the sector of plastics materials, the dehumidification stage is particularly important in the case of hygroscopic polymers, for instance PA, ABS, PET, TPU, PC, etc., which tend readily to absorb a substantial quantity of water.

One of the known drying, or dehumidifying, systems consists in loading the material into a container provided with at least one infrared radiating device which radiates the material in order to heat it and help to evaporate any moisture that it may contain.

The container, made from metal material, is filled to a certain level with the material to be treated so that the radiating devices are positioned at a certain distance from the material being treated.

In the case of material of low permeability, the infrared radiation penetrates the material being treated to a limited depth, with the result that part of the material is effectively treated, while the remaining part, disposed furthest from the radiating device, is not reached by the radiation and is not therefore effectively dehumidified.

In order to remedy this drawback, a mixer is installed that mixes the material being treated in such a way that fresh material continues to be brought into the sphere of action of the radiating device in order to be effectively treated. The dehumidifying effect of the radiation may be increased by placing the material in the container under vacuum or by supplying the container with hot and dry air.

Treatment devices for flowable material of the type described above are known, for instance, from WO2010089721 and WO2010109403.

A drawback of these known devices is that the internal walls of the container become overheated especially in the area close to the radiating devices, i.e. in the area not containing material to be treated.

This area is continuously and directly exposed to the action of the radiating devices and the walls reach temperatures which may be very high, possibly higher than the melting point of the material being treated, or in any case such as to cause the material to deteriorate or become degraded if it comes into contact with the walls in this area.

A further drawback of these devices is that, during treatment, particles of the material being treated may be attracted by the walls of the container under the effect of static electricity and may thus accumulate while continuing to be exposed to the radiation until they melt or become degraded.

This is a particular problem in the case of materials with very small particle dimensions or powdered materials. This problem is most pronounced in cases in which a mixer is provided to move the flowable material because particles of material are more often attracted by and continue to adhere to the container wall.

Moreover, after a portion of the material has started to melt, new material tends to stick to the melted material and then in turn to melt, thus increasing the problem proportionately to the length of the treatment. This melting and/or degradation of the material being treated is prejudicial to the properties of the end product and may cause problems during subsequent processing.

In the case of plastics material, melting creates blocks of material which cannot be processed by processing machines, while heat degradation causes, as mentioned above, a loss of aesthetic and mechanical properties and is detrimental to the material's subsequent processability.

In food products, overheating causes a loss of organoleptic properties which is detrimental to the value of the final product and the use of the material and/or its subsequent processability.

### DESCRIPTION OF THE INVENTION

An object of the invention is to provide a treatment device for flowable material which makes it possible to remedy the drawbacks discussed above with reference to the known prior art.

A further object is to provide a treatment device with low energy consumption during operation which makes it possible effectively to treat the flowable material in considerably shorter times.

These objects of the present invention are achieved by a treatment device for flowable material embodied in accordance with the appended claims.

### BRIEF DESCRIPTION OF THE DRAWINGS

Other advantages and features of the invention will become clear from the following detailed description of a preferred embodiment thereof, given with reference to the appended drawings which are provided purely by way of non-limiting example and in which:

FIG. 1 is a diagrammatic view of a treatment device of the invention;

FIG. 2 is a top view in cross-section of the device of FIG. 1;

FIG. 3 is a view on an enlarged scale of an alternative version of a detail of FIG. 1;

FIG. 3a is a view on an enlarged scale of a detail of FIG. 3;

FIGS. 4 and 5 are partial views of two alternative versions of the detail of FIG. 3;

FIG. 6 is a diagrammatic view of an alternative version of the treatment device of the invention.

FIG. 7 is a diagrammatic view of a further alternative version of the treatment device of the invention;

FIG. 8 is a diagrammatic view of a still further alternative version of the treatment device of the invention;

FIG. 9 is a view on an enlarged scale of an alternative version of the scraping device of the invention;

### PREFERRED EMBODIMENT OF THE INVENTION

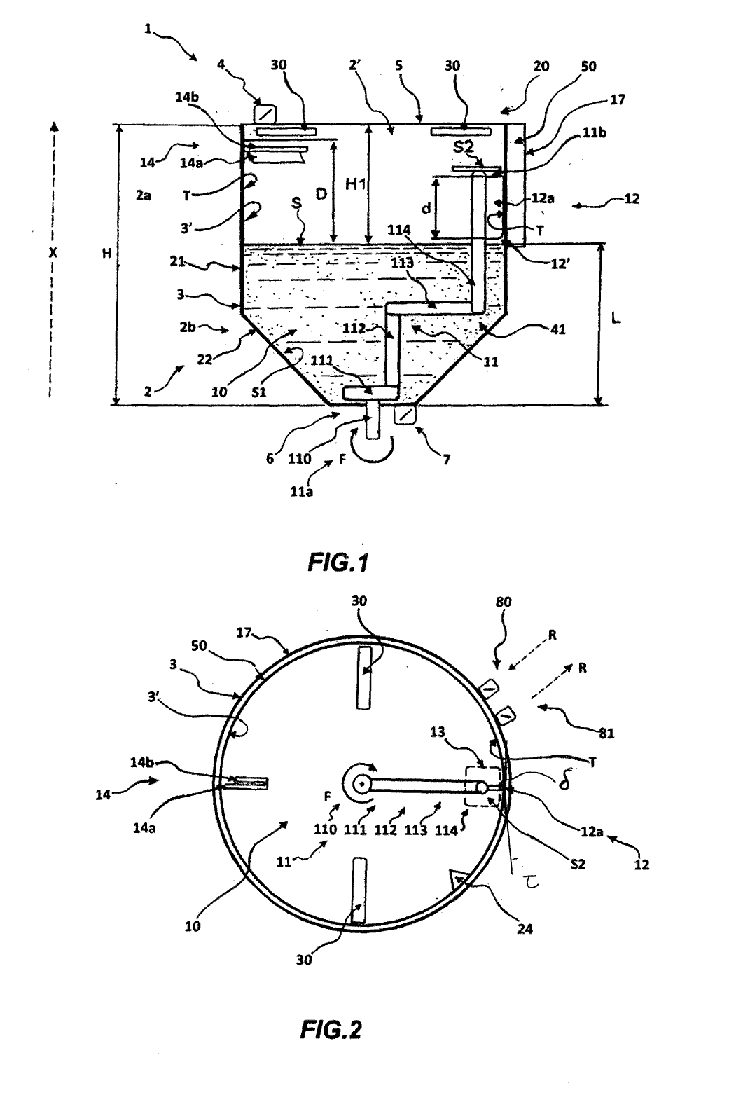

FIG. 1 shows a treatment device for flowable material 1 of the invention in diagrammatic form.

The treatment device is particularly suited to the treatment of plastics material, such as PET, PA, PC, PMMA, bioplastics such as PLA, etc., food material such as coffee, rice, peanuts or even ground herbs, clay, etc.

The treatment device of the invention is suited to the treatment of flowable material in the form of granules, powder, flakes, paste or liquid.

The device of the invention may be used in a conventional processing plant for plastics materials or included in treatment plants for flowable material which include a stage of heat treatment.

The treatment device 1 comprises a container body 2 bounded by a wall 3 and designed to contain the material to be treated. The container body 2 is shaped as a hopper of circular cross-section which has a cylindrical portion 21 and a frustoconical portion 22 which are connected to one another. The container body 2 is made from metal material, for instance stainless steel, or from another material resistant to temperatures of at least 100° C. or more.

In other embodiments, the container body 2 may have a cylindrical shape or polygonal cross-section formed by a polygon having a desired number of faces. The actual geometry of the container body 2 depends on constructional, installation, process, cost and other considerations.

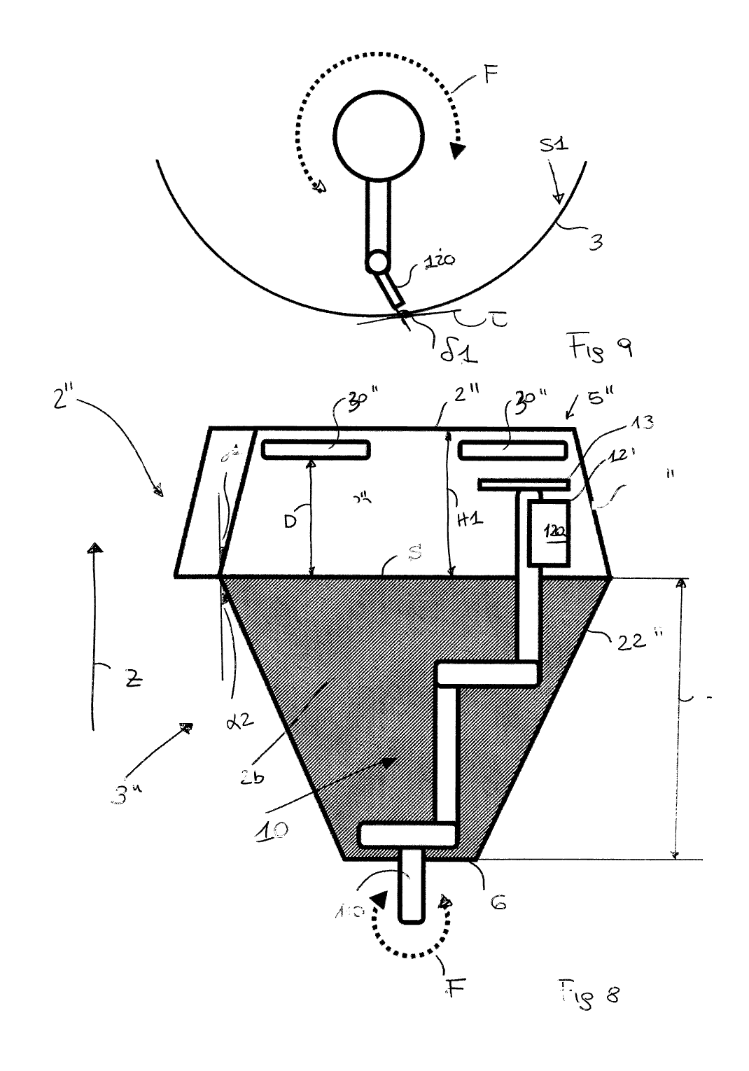

In an alternative versions, shown in FIGS. 7 and 8, in which corresponding parts are indicated with corresponding reference numbers, the wall 3′ of the container body 2′ comprises a first 21′, and a second 22′ frustoconical portions, and respectively first 21″, and a second 22″ frustoconical portions, so positioned that the circumference of the container body changes along the height of the container 2, i.e. along the axis X.

In this way, the sliding of the material to be treated on the wall 3′, or 3″ it is enhanced and the removal of the material form the wall 3′, or 3″, is favoured, as will be explained in further detail in the followings.

In the version shown in FIG. 7, the first 21′ and the second 22′ frustoconical portions are so positioned that the corresponding highest circumference face one another, a cylindrical portion being interposed between the first 21′ and the second 22′ frustoconical portions.

In the version shown in FIG. 8, the first 21″ and the second 22″ frustoconical portions are mutually connected at the highest circumference, the container 2″ having a rhomboid longitudinal cross section.

In a further version not shown, the first and the second frustoconical portions are mutually connected at the littlest circumference, the container having a longitudinal cross section shaped as a hour-glass.

The first and the second frustoconical portions may be tilted in relation to the longitudinal axis Z of an angle α1, α2, having the same value or a different value; the value of the tilt angle(s) α1, α2, being chosen so as to enhance the sliding of the material on the wall of the first and the second frustoconical portions.

The treatment device 1 is designed to operate at ambient pressure, but may also be configured to operate under vacuum or under pressure.

In this case, the treatment device 1 is leak-tight and devices are provided to generate the vacuum or pressure and are operationally connected to the container 2 for the material to be treated, as is the case of the devices disclosed in WO2010089721 and WO2010109403. Control devices such as valve and manometers are also provided to control and regulate the pressure level or vacuum within the container body.

The container body 2 comprises a mouth 2′ provided in the cylindrical portion 21 which may be hermetically sealed by a cover 5.

In embodiments which are not shown, the cover 5 comprises two walls spaced from one another by a gap of approximately 3-5 cm in order to reduce heat dispersion. In the case in which the container body 2 is under vacuum, this gap also insulates it from the external environment.

The cover 5 may be removed and may be opened manually or by lifting devices (not shown).

The container body 2 comprises an inlet valve 4 provided in the cover 5 which is opened so that the flowable material can be loaded into the container body 2 and closed during treatment.

In embodiments which are not shown, the inlet valve 4 is positioned on the wall 3 of the container 2, preferably in the cylindrical portion 21, or in the version of FIGS. 7 and 8 in the first frustoconcal portion 21′ or 21″, and/or in an area of the container 2 facing the cover 5.

The container body 2 is provided with a base 6 in which an outlet valve 7 is provided and positioned on the opposite side with respect to the inlet valve 4 in order to enable the material to be discharged from the container 2.

In an embodiment which is not shown, the flowable material is loaded into and discharged from the container 2 via the same opening.

The treatment device 1 further comprises a radiating device 20 designed to radiate infrared radiation into the container body 2 in order to heat and dehumidify the flowable material.

In the embodiment shown, the radiating device 20 is formed by two dual-tube infrared radiation lamps 30, with a tungsten or carbon filament, mounted within quartz tubes.

Use may be made of radiating devices 20 which emit infrared rays at a fixed, long, short or medium wavelength or radiating devices 20 which emit waves whose wavelength may be varied through the appropriate use of Wien's law, i.e. by varying, in a controlled manner, the temperature of the infrared radiation generator for instance by varying the temperature of the tungsten filament in the case of lamps.

The type and/or number of lamps 30 and/or their emission wavelength depend on the type and quantity of the material being treated in the container body 2 and on the dimensions of the container body 2.

The lamps 30 are coupled to the cover 5 and positioned so as to emit the infrared radiation in the direction of the material being treated.

The treatment device 1 further comprises one or a plurality of temperature sensors (not shown) in order to monitor the temperature of the material being treated and/or the container body 2 and/or the wall 3 and/or the lamps 30, so as to adjust the heating of the flowable material.

The flowable material is loaded into the container body 2 so as to fill it to a certain level L, lower than the overall height H of the container body 2 defined between the base 6 and the mouth 2′, so that the free surface S of the flowable material is spaced by a distance D from the lamps 30 in order to prevent localized overheating or melting of the flowable material closest to the lamps 30.

The value of the distance D is selected in accordance with the dimensions of the container 2 and the lamps 30: for instance, the distance D is approximately 100 mm in the case of a 5-litre container and approximately 800 to 1000 mm in the case of a 2000-litre container.

The container body 2 therefore has an empty portion 2a between the lamps 30 and the free surface S of the flowable material which is free from material and a full portion 2b between the base 6 and the free surface S in which the flowable material to be treated is disposed. In the empty portion of the container 2a, the wall 3 has a free stretch of wall 3′ having an extension H1 between the free surface S and the mouth 2′ which is free from material and is thus directly exposed to the radiation emitted by the lamps 30 and may therefore also reach high temperatures.

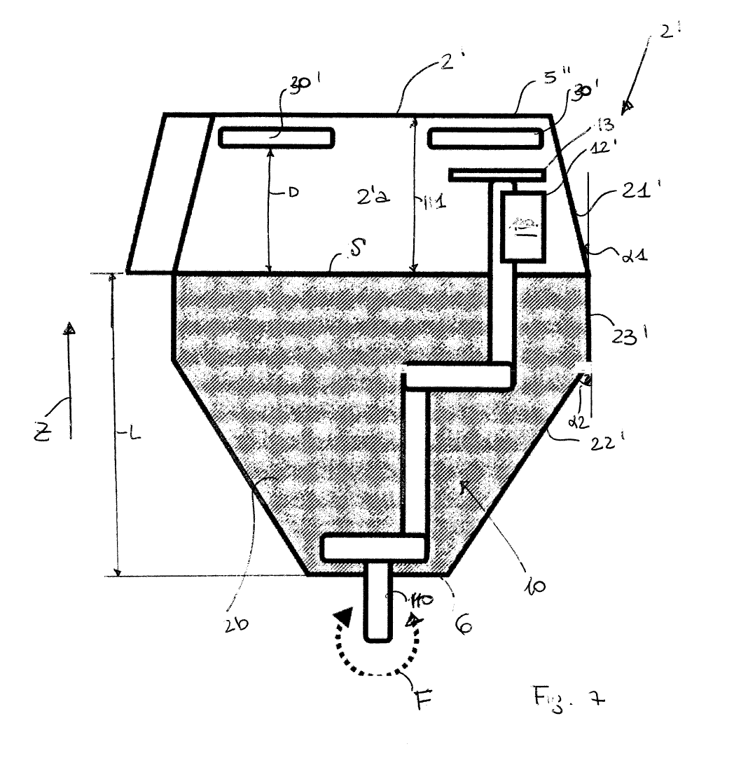

Particles or powder of the flowable material being treated in the container body 2 are attracted under the effect of static electricity onto the wall 3 of the container body 2, in particular the free stretch of wall 3′, and adhere thereto. In this way, as they are directly and continuously exposed to the infrared radiation reaching the free stretch of wall 3′, these particles are overheated and may be subject to thermal degradation or may even melt. This problem is particularly pronounced when the treatment device 1 is provided with a mixer to move the flowable material and promote its homogeneous treatment, as in the embodiment shown in FIG. 6: the movement of the material by the mixer brings a greater quantity of particles onto the free stretch of wall 3′ to which they then adhere under the effect of static electricity.

The container body 2 is provided with a cleaning device 10 designed to keep the free stretch of wall 3′ clean, as will be explained below.

The cleaning device 10 comprises a mixing device 11 hinged at its first end 11a to a pin 110 projecting from the base 6 into the container 2 and extending perpendicular thereto. The pin 110 is operationally connected to a motor (not shown) positioned externally to the container body 2 and designed to cause the cleaning device 10 to rotate about an axis of rotation X in both directions of the arrow F.

The motor is connected to the pin 110 in such a way as to ensure that the container body 2 is hermetically sealed and that motion is transmitted to the mixing device 11. The actuation of the motor causes the cleaning device 10 to rotate at low speeds, preferably less than 2 rpm, the actual speed being selected in accordance with the type of material being treated and the geometry of the container 2.

In the embodiment shown, the axis of rotation X coincides substantially with the longitudinal axis Z of the container body, i.e. the axis defined between the mouth 2′ and the base 6; in other embodiments, however, the cleaning device 10 may be rotated about an axis differing from the longitudinal axis of the container 2 and inclined with respect thereto.

The mixing device 11 extends within the container body 2 in a determined direction between the mouth 2′ and the base 6 along the full container portion 2b and at least partially into the empty container portion 2a and is designed to mix the flowable material in the container body 2 during the rotation of the cleaning device 10.

The cleaning device 10 further comprises a scraping device 12 fixed at an end zone 11b of the mixing device 11 opposite the first end 11a, and intended to scrape the inner surface S1 of the wall 3 of the container body 2 during the rotation of the cleaning device 10 in order to scrape off any particles of plastics material on the internal surface S1.

The scraping device 12 is arranged for scraping off any particles of plastics material from the free stretch of wall 3′ and for conveying the material previously adhered on the free stretch of wall 3′ to the container so that the material can be processed, as will be explained in greater detail in the following.

In the embodiment shown in FIG. 1, the mixing device 11 comprises a plurality of mutually hinged arms 41 interposed between the pin 110 and the scraping device 12, configured such that motion is transmitted by the motor to the scraping device 12 disposed in such a way that two adjacent arms are almost perpendicular to one another.

The plurality of arms 41 comprises in sequence a first horizontal arm 111 hinged on the pin 110 and extending in a direction almost parallel to the base 6, a second arm 112 parallel to the pin 110, a third arm 113 parallel to the first arm 111 and a fourth arm 114 parallel to the pin 110 on which the scraping device 12 is fixed.

The arrangement and the number of arms of the plurality of arms 41 is selected according to the geometry and dimensions of the container body 2 and is selected so as to obtain an overall configuration of the cleaning device 10 able to mix the flowable material and not to interfere with other devices which may be positioned within the container body 2, for instance the lamps 30 and/or a mixing device as shown in FIG. 6, or any projections secured internally to the wall 3, projecting into the container 2 and designed to facilitate the mixing of the material being treated in the full container portion 2b.

In other embodiments, the arms of the plurality of arms 41 are disposed such that two successive arms are incident to one another and inclined by an angle other than 90°.

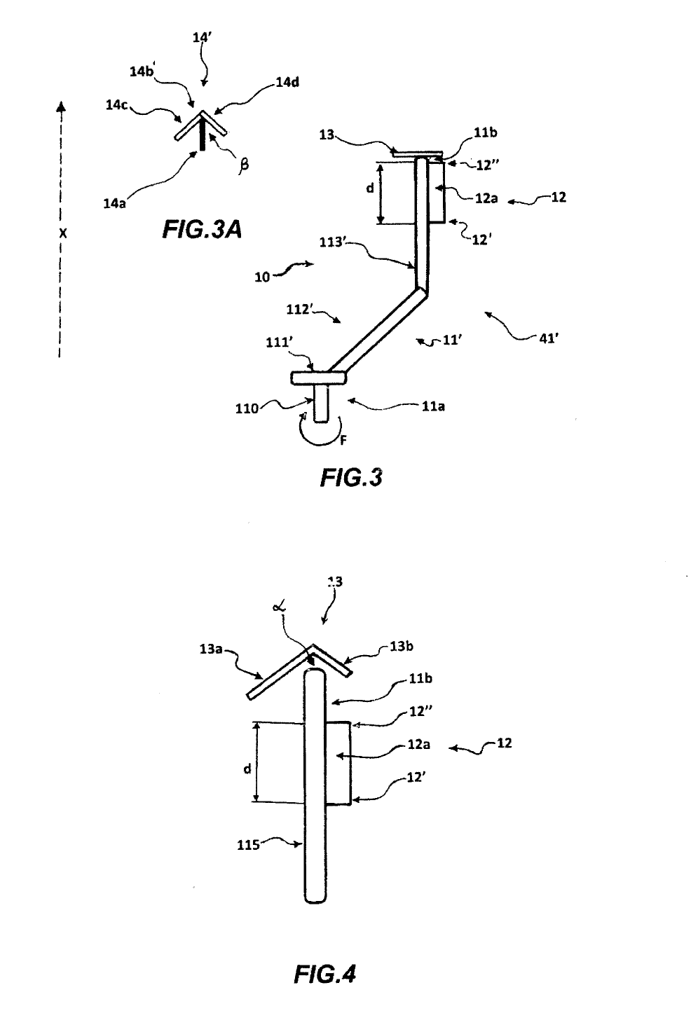

In the embodiment of the cleaning device 10 shown in FIG. 3, in which identical components are indicated with corresponding reference numerals, the plurality of arms 41′ comprises a first horizontal arm 111′ hinged on the pin 110 and extending in a direction almost parallel to the base 6, a second arm 112′ disposed in an incident direction both with respect to the pin 110 and the first arm 111, and a third arm 113′ parallel to the pin 110 on which the scraping device 12 is fixed.

The arms of the plurality of arms 41′ are disposed such that the arm to which the scraping device 12 is fixed, i.e. the fourth arm 114 in the embodiment of FIG. 1 and the third arm 113′ in the embodiment of FIG. 3, are substantially perpendicular to the internal surface S1.

In other embodiments which are not shown, the mixing device 11 comprises a single body extending in the container body 2, one end of which is fixed to the scraping device 12 shaped such that it can efficiently mix the material being treated and not interfere with other devices which may be present in the container 2.

The scraping device 12 comprises a spatula 12a designed to run over the inner surface S1 of the wall 3 during the rotation of the cleaning device 10. The spatula 12a has a length d corresponding to or less than the distance D between the radiating means 20 and the free surface S, i.e. a length d smaller than or equal to the extension H1 of the free stretch of wall 3′ so as to scrape off the flowable material adhering to at least a segment T of the free stretch of wall 3′ corresponding to the length d of said spatula.

The spatula 12a comprises a scraping edge facing the wall 3 of the container that is arranged for running over the inner surface S1 of the wall 3 in order to scrape off any particles therefrom. In the version shown in FIGS. 1 and 2, the scraping edge of the spatula 12a is substantially parallel to the inner surface S1 of the wall 3, i.e. the angle formed between the spatula 12a and the inner surface S1 is about 0° (or 180°).

Nevertheless in further versions the spatula 12a may be tilted in relation to the surface S1, i.e. positioned at an angle δ in relation to the internal surface S1 of the wall 3 that is comprised between 0° and 180°.

For example in the version shown in FIGS. 7 and 8 the spatula 12′a and 12″a respectively, is tilted in relation to the surface S1 of the first frustoconical portion 21′ or 21″ respectively.

Moreover in the version shown in FIG. 9 the spatula 120 is tilted in relation to the surface S1 of the wall 3 of an inclination angle δ1, i.e. the angle formed between the spatula 120 and the tangent τ passing through the contact point between the spatula 120 and the wall 3, may be comprised between 0° and 180°.

The real value of the inclination angle δ or δ1 is chosen taking into account the rotation direction of the cleaning device 10, the rotation speed of the cleaning device 10, the plastics material to be treated, the position and the type of the heating devices, etc. This prevents the overheating of the particles on the free stretch of wall 3′ and therefore damage or deterioration due to the overheating or even melting of those particles.

In particular, one end 12′ of the spatula 12a is disposed at more or less than same level as the free surface S, while the opposite end 12″, i.e. the end facing the lamps 30, is disposed at a distance from said lamps 30 such as to prevent excessive overheating of the spatula 12a itself. The actual length d of the spatula 12a is selected in accordance with the dimensions of the container 2 and constructional requirements to prevent reciprocal impediments between the devices in the container 2.

The spatula 12a is made from flexible material able to withstand temperatures of more than 100° C., for instance spring steel, silicone, etc., and is secured to the mixing device 11 in such a way that it is positioned in the empty container portion 2a.

The flexible material of the spatula is so chosen that the spatula is deformable when it slides over the wall 3 of the container, so that particles of plastics material adhered on the free stretch of wall 3′ are somehow lifted and removed from the wall 3 and conveyed into the container, as will be explained in greater detail in the following.

In other embodiments which are not shown, the scraping device 12 comprises one or a plurality of scraping brushes able to run over at least a segment T of the free stretch of wall 3′ in order to remove any particles therefrom and whose bristles are made from an appropriate material, for instance steel or silicone.

Also in this case, the bristles of the scraping brushes are made from a flexible material so that the bristles are deformable when the brush(es) slide(s) over the wall 3 of the container in order to remove the particles of plastics material from the wall 3′ and to convey the particles of plastics material towards the container.

The material of the bristles and/or the spatula is selected according to the temperature that may be reached by the free stretch of wall 3′.

The cleaning device 10 further comprises a shielding element 13 fixed to a second end 11b′ of the mixing device 11 opposite said first end 11a and positioned so as to be placed between the lamps 30 and the scraping device 12 in order to shield against the infrared radiation emitted by the lamps 30 and to prevent it from directly striking the scraping device 12.

The shielding element 13 creates a shaded zone in which the scraping device 12 is disposed in order to prevent it from overheating and thus to prevent localized melting of the flowable material in contact with it.

The shielding element 13 is substantially perpendicular to the fourth arm portion 114 to which the scraping device 12 is fixed, is formed as a plate which is rectangular, circular or shaped to match the shape of the wall 3 and is preferably made from metal material, for instance stainless steel, able to withstand the temperatures generated by the lamps 30.

The container body 2 is further provided with a scraper 14 secured to the free stretch of wall 3′ in an intermediate position between the lamps 30 and the shielding element 13 and shaped so that the scraper 14 interacts during the rotation of the cleaning device 10 with the shielding element 13 in order to remove any flowable material.

Also in this case the scraper 14 is arranged for removing any material from the shielding element 13 and to convey the material into the container 2. The scraper 14 comprises a further shielding element 14b and a further spatula 14a designed to run over the surface S2 of the shielding element 13, which faces the lamps 30 in operation, during the rotation of the cleaning device 10.

In this way, any flowable material which falls on the shielding element 13 during loading of the treatment device 1 or during the treatment itself is removed, thereby preventing any melting.

The further screening element 14b is interposed between the lamps 30 and the further spatula 14a, substantially parallel to the shielding element 13 and has dimensions such as to shield the further spatula 14a and prevent it from directly struck by the radiation emitted by the lamps 30.

The further shielding element 14b creates a shaded zone which prevents the radiation from striking the further spatula 14a directly. The further shielding element 14b is shaped as a rectangular plate, as shown in FIG. 2, or may be circular or shaped to match the shape of the wall 3.

FIG. 3a shows an alternative embodiment of the further shielding element 14b′ comprising two flaps 14c, 14d appropriately inclined with respect to vertical and mutually incident such that the further screening member 14b′ is shaped as an upturned V. The flaps 14c, 14d have the same dimensions as in the embodiment of FIG. 3, or different dimensions, and are disposed to form an incident angle β preferably of between 60° and 160°.

The further spatula 14a has a length equal to or greater than the shielding element 13 in order to ensure that it cleans substantially the whole of the surface S2, and is made from flexible material able to withstand temperatures of more than 100° C., for instance spring steel, silicone, etc.

In other embodiments which are not shown, the scraper 14 comprises one or a plurality of scraping brushes able to run over the shielding element 13 in order to remove any particles adhering thereto and whose bristles are made from an appropriate material. The material of the bristles and/or the spatula is selected according to the characteristics of the radiating means 20.

In an embodiment, the spatula 12a and the further spatula 14a are made from the same deformable material so as to efficiently remove the material form the wall 3, or from the shielding element 13 respectively, and to convey the material into the container 2.

A single scraper 14 is provided in the embodiment shown, and the shielding element 13 is cleaned only once during each rotation of the cleaning device 10. In other embodiments which are not shown, a plurality of scrapers 14 are provided and positioned in an appropriately spaced position on the inner surface S1 of the wall 3 in order to increase the frequency of cleaning of the shielding element 13.

FIG. 4 shows an alternative embodiment of the shielding element 13 comprising two flaps 13a, 13b appropriately inclined with respect to vertical and mutually incident such that the shielding member 13 is shaped as an upturned V. The flaps 13a, 13b may be of different dimensions as in the embodiment of FIG. 4, or of the same dimensions, and are disposed to form an incident angle α preferably of between 60° and 160°.

In embodiments which are not shown, the shielding element has a conical shape with its vertex facing the lamps or is formed by a single flap appropriately inclined with respect to vertical. In these configurations, the inclination of the walls of the shielding element 13 makes it easier for any deposits of flowable material to fall from the shielding element 13 into the container 2.

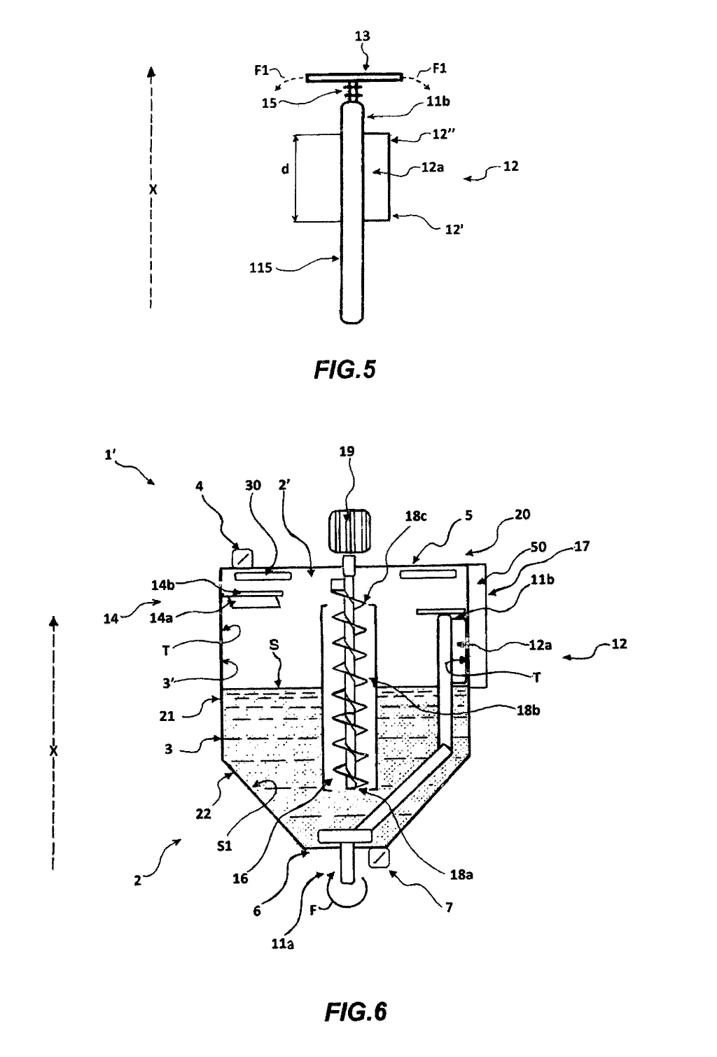

FIG. 5 shows a further embodiment of the shielding element 13 in which the latter is secured to an oscillating member 15 secured at the second end 11b of the mixing device 11 and disposed to oscillate about the axis X′ of the arm to which the shielding element 13 is secured, as shown by the arrows F1 in FIG. 5.

During the rotation of the mixing device 10, the oscillating member 15 is moved thereby causing the shielding element 13 to oscillate. In this way, any residues of material on the shielding member 13 are caused to fall, preventing their overheating.

To promote the oscillation of the oscillating member 15, the inner surface S1 of the wall 3 is provided with a tooth 24, shown in FIG. 2, projecting into the container 2 and positioned in a position such that it contacts the oscillating member 15 during the rotation of the cleaning device 10 so as to cause it to oscillate.

The oscillating member 15 may be a spring or a flexible support which enables an oscillation/vibration of the shielding element 13 in order to help to remove any material deposited on it.

In other embodiments which are not shown, two or a plurality of cleaning devices 10 and/or two scraping devices 12 secured to the cleaning device 10 in mutually spaced positions, for instance diametrically opposed, are provided in order to make the cleaning of the free stretch of wall 3′ more effective.

The container 2 is further provided with a covering wall 17 positioned outside the free stretch of wall 3′ and arranged such that between the latter and the covering wall 17 there is a hermetically sealed cooling gap 50 in which a coolant, such as water, air, oil, glycol, etc., is made to circulate in order to cool the free stretch of wall 3′ and prevent it from overheating.

The cooling gap 50 extends over a substantial portion of the free stretch of wall 3′ or over the whole of the free stretch of wall 3′. The covering wall 17 is provided with at least a first valve and a second valve 80, 81 for the inlet and outlet of the coolant in the cooling gap 50: the valves 80, 81 are disposed such that the passage of the coolant in the cooling gap 50 makes it possible homogeneously to cool the free stretch of wall 3′ or a substantial portion thereof.

Baffles may be provided in the cooling gap in order to provide a desired configuration of the circuit for the coolant in order to make the cooling more homogeneous.

The free stretch of wall 3′ may be provided with temperature probes to detect the temperature of the free stretch of wall 3′ and/or the coolant entering and being discharged from the cooling gap 50.

In an embodiment which is not shown, more than two valves are provided and the cooling gap 50 may be divided into two or a plurality of portions independent from one another so as to provide a plurality of independent cooling circuits. This makes it possible further to increase the efficiency of the cooling of the cooling gap 50.

The inlet flow and temperature of the coolant are such as to ensure that the temperature of the free stretch of wall 3′ is lower than the temperature at which the material being treated deteriorates or melts and also to avoid excessive overheating of the free stretch of wall 3′ so as not to remove heat unnecessarily from the system, thereby wasting energy. In the case of the treatment of PET, the temperature of the free stretch of wall 3′ must be below 240-260° C. in order to prevent the PET from deteriorating or melting.

The cleaning device 10 and/or the cooling in the cooling gap 50 make it possible to prevent the flowable material on the free stretch of wall 3′ from deteriorating or melting.

In other embodiments, the treatment device 1′ further comprises a mixing device 16, configured for instance as the screw 18 of the embodiment shown in FIG. 6, positioned in the container body 2 in order to mix the flowable material therein.

The treatment device 1′ shown in FIG. 6 is embodied, and is not therefore described in detail here, in accordance with the teaching of WO2010109403. The screw 18 is actuated by a relative actuation motor 19 and comprises an inlet 18a via which the material enters the screw 18, a body 18b along which the material is moved and an outlet 18c from which the material is discharged from the screw 18 which is positioned in the vicinity of the radiating means 20.

In this way, the material being discharged from the screw 18 enters the zone of action of the lamps 30 and is subject to heating and dehumidification.

The presence of the screw 18 improves the mixing of the flowable material and the effectiveness of the treatment. Any particles of material deposited on the free stretch of wall 3′ and/or on the shielding element 13 are removed therefrom in the manner described above and conveyed into the container.

In other embodiments which are not shown, use may be made of further drying agents, for instance microwaves, vacuums or hot and dry air in addition or as an alternative to the infrared radiation.

The dehumidifying device 1 of the invention may also be used in the upgrading of PET, i.e. the so-called “Solid State Polycondensation” (SSP) treatment. Upgrading takes place at a temperature of up to 230° C. and is particularly suited to the recovery of recycled material (PET obtained from recycled bottles and containers, in order to return the viscosity lost during extrusion operations) or the improvement of the properties of unprocessed material when viscosity has to be increased to increase its mechanical strength. This process is generally carried out by heating the material and then storing it in a vacuum environment (autoclave). The advantage of the present invention lies in the fact that the PET can be heated very rapidly with the infrared radiation while at the same time keeping it in an oxygen-free environment and ensuring that the material being treated is at a constant temperature, thereby preventing it from deteriorating or melting. The efficiency of the process is improved in this way, and energy consumption is also reduced.

The scraping device 12 by scraping the material off form the wall 3 and conveying the material into the container 2 makes it possible to prevent the plastics material from deteriorating or melting as a result of the overheating of the free stretch of wall 3′ which is constantly and directly exposed to the action of the radiating means 20.

The scraping device 12 prevents the accumulation of material on the free stretch of wall 3′ as a result of electrostatic charging, especially in the case of powders, which causes the material to be heated beyond its melting point or a heat degradation of the material.

Moreover the scraping device 12 and/or the scraper 14 scrape off the material form the wall 3 or form the shielding device 13 respectively, and conveys the scraped off material into the container without damaging the latter.

In other words the spatula 12a, or respectively the scraping brushes or further spatula 14a, being made from flexible material scrape off the material form the wall 3 without crushing the material.

The cleaning device 10 prevents the material from stagnating because it is not, inadequately or incorrectly mixed which, as above, causes the material to overheat.

In the operation of the treatment device 1, the container body 2 is firstly filled via the inlet valve 4 with the material to be treated up to a certain level L, the valve 4 is closed and the lamps 30 are actuated in order to heat the material in the container body 2 and the cleaning device 10 is then actuated and, by means of the scraping device 12, keeps the free stretch of wall 3′ free from deposits or accumulations of material.

In this way, any material adhering to the free stretch of wall 3′ as a result of electrostatic charging, or deposited in the vicinity of the free stretch of wall 3′, is moved and prevented from melting.

At the same time, the overheating of the scraping device 12 is prevented by means of the shielding element 13 and the latter is also kept clean by means of the scraper 14.

If necessary, the cooling means are also actuated so as to the cool the cooling gap 50 in order to counter the heating of the free stretch of wall 3′ as a result of the radiation emitted by the radiating means 20.

When the treatment is complete, i.e. when the material has been kept at a temperature for a certain period of time, which is selected in accordance with the type of material, the outlet valve 6 is opened and the flowable material is discharged from the container 2.

1. Treatment device for flowable material comprising a container body suitable for receiving a predefined quantity of said flowable material and delimited by a wall, at least one radiating device which radiates infrared radiation to heat said flowable material in said container body, a cleaning device fixed at one end thereof to a base of said container body and rotatable around an axis (X) of said container body, wherein said cleaning device is provided with a scraping device provided at an end portion of said cleaning device, said end portion being opposite said first end and arranged to run in the rotation of said cleaning device over at least one segment of a free stretch of the wall defined between a free surface of said material and a mouth of said container said scraping device being made of flexible material in order to scrape off any residues of said flowable material from said at least one segment of said free stretch of wall and to convey said removed material into said container in order to be treated.

2. The treatment device according to claim 1, wherein said scraping device comprises a spatula arranged to run over said at least one segment of said free stretch.

3. The treatment device according to claim 1, wherein said scraping device comprises at least one brush arranged to run over said at least one segment of said free stretch.

4. The treatment device according to the claim 3, wherein said spatula or said brush are made of a flexible material so as be deformed when said spatula or respectively said brush run over said at least one segment of said free stretch.

5. The treatment device according to the claim 4, wherein said material is silicone or steel.

6. The treatment device according to claim 1, and further comprising a shielding element fixed to a second end of said cleaning device opposite said first end and positioned so as to be placed between said at least one radiating device and said scraping device in order to shield against the infrared radiation emitted by said at least one radiating device and to prevent it from striking said scraping device.

7. The treatment device according to claim 6, wherein said shielding element is fixed to an oscillating element provided on said second end and arranged to oscillate around an oscillation axis of said cleaning device so as to make said shielding element oscillate.

8. The treatment device according to claim 7, and comprising a scraping element fixed to said wall and protruding into said container and shaped so as to scrape a surface of said shielding element during the rotation of said cleaning device in order to eliminate any flowable material from said surface, said surface being turned towards said at least one radiating device.

9. The treatment device according to claim 8, wherein said scraping element is made of a flexible material.

10. The treatment device according to claim 1, wherein said cleaning device comprises a mixing device rotatably hinged to said base and being extended into the container body from said base towards said at least one radiating device so as to run through the flowable material and arranged to mix said flowable material through the rotation of said cleaning device.

11. The treatment device according to claim 10, wherein said mixing device comprises a plurality of mutually hinged arms extending into said container body, said scraping device being fixed to one arm of said plurality of arms.

12. The treatment device according to claim 1, and further comprising a screw mixer element for mixing the flowable material in said container body.

13. The treatment device according to claim 12, and further comprising a covering wall positioned outside said wall over at least said free stretch of wall and arranged such that between said free stretch of wall and said covering wall there is located a cooling gap in which a coolant is made to circulate in order to cool said free stretch of wall.
